(19) United States
(12) Patent Application Publication
(10) Pub. No.: US 2006/0208876 A1
(43) Pub. Date: Sep. 21, 2006

(54) Transmitter/receiver apparatus for sensor signals and transmission system for wireless transmission of sensor signals

(75) Inventors: Andreas Kirchner-Gellert, Aichwald (DE); Peter Dolderer, Esslingen (DE); Manfred Jagiella, Notzingen (DE)

Correspondence Address: Lipsitz & McAllister, LLC, 755 MAIN STREET, MONROE, CT, 06468, US

(73) Assignee: BALLUFF GmbH, Neuhausen (DE)

(21) Appl. No.: 11/354,572

(22) Filed: Feb. 14, 2006

(30) Foreign Application Priority Data
Feb. 21, 2005 (DE) 10 2005 009 312.4

(51) Int. Cl. G08B 1/08; H04B 1/44; B23K 11/24; H04L 12/26; G08C 19/16

(52) U.S. Cl. 340/539.1; 340/870.01; 307/112; 370/229; 455/78

(57) ABSTRACT

There is provided a transmitter/receiver apparatus for sensor signals, comprising a transmitting device for wirelessly transmitting signals, a receiving device for receiving wirelessly transmitted signals, a connection device to which at least one sensor is connectable for signal input, and which has at least one connection for signal output, and a control device which is connected to the connection device, the transmitting device and the receiving device, wherein the signal traffic between the connection device, the transmitting device and the receiving device is controllable by means of the control device.

The present disclosure relates to the subject matter disclosed in German application No. 10 2005 009 312.4 of Feb. 21, 2005, which is incorporated herein by reference in its entirety and for all purposes.

### BACKGROUND OF THE INVENTION

The invention relates to a transmitter/receiver apparatus for sensor signals.

The invention further relates to a transmission system for wireless transmission of sensor signals.

In certain sensor applications, it is advantageous for the sensor signals delivered by one sensor or a plurality of sensors to be wirelessly transmittable. In particular, there is then no necessity for cables between sensors and an evaluating device or an actuator which is controlled by sensor signals.

### SUMMARY OF THE INVENTION

A transmitter/receiver apparatus for sensor signals is provided, by means of which sensor signals are wirelessly transmittable, and which is universally usable.

In one embodiment of the invention, a transmitting device for wirelessly transmitting signals is provided, a receiving device for receiving wirelessly transmitted signals is provided, a connection device is provided, to which at least one sensor is connectable for signal output, and which has at least one connection for signal output, and a control device is provided, which is connected to the connection device, the transmitting device and the receiving device, wherein the signal traffic between the connection device, the transmitting device and the receiving device is controllable by means of the control device.

Such a transmitter/receiver apparatus is universally usable. Sensor signals can be transmitted and/or sensor signals can be received with it. Unidirectional transmit operation or receive operation can be carried out or bidirectional transmit/receive operation, in which sensor signals are both transmitted and received.

Furthermore, a plurality of sensors and/or a plurality of actuators can also be coupled to it. In particular, multi-channel operation is achievable in a simple way.

Diagnosis signals or parameterization signals can also be transmitted and/or received.

In particular, the control device comprises an evaluating device for signal evaluation. A “signal shaping” can thus be carried out with respect to the transmitted or received signals so as to enable simple transmitting or simple triggering of an actuator. Sensor switching states, for example, can be evaluated by the evaluating device.

It is expedient for the connection device to comprise at least one input connection and at least one output connection. In this way, signals can be read in and signals can be coupled out. Transmit operation and receive operation are then both possible.

It is expedient for a plurality of input connections to be provided. A plurality of sensors can thus be coupled to them. The transmitter/receiver apparatus can then be used as “transmission box”, by means of which sensor signals of a plurality of sensors are transmittable.

For the same reason, it is expedient for a plurality of output connections to be provided. In this way, a plurality of actuators can be triggered.

In principle, it is possible for the at least one input connection and the at least one output connection to be spatially separated. It is thus easily possible to simultaneously connect at least one sensor and at least one actuator.

It is also possible for at least one connection to be provided, which is switchable as input connection or output connection. For example, it is specified by the control device whether the connection in question is provided for input or for output, with this function being alterable with respect to time. This can be advantageous when there is a small amount of space available for positioning the transmitter/receiver apparatus in an application.

It is also expedient for a setting device to be provided for setting at least one connection of the connection device as input connection or output connection.

The connection configuration of the transmitter/receiver apparatus can thus be specified by an operator and thereby optimally adapted to an application. If, for example, it is not necessary for signals to be outputted, then all connections can be set as input connections.

It can be provided that the transmitting device and the receiving device are integrated into a transceiver module. The transceiver module is, for example, a radio module. Such radio modules are commercially available.

In particular, the transmitting device is configured as radio transmitting device, and the receiving device is configured as radio receiving device. In principle, there are a multiplicity of possibilities for wireless data transmission. For example, data can be transmitted by infrared transmission. However, the range here is relatively low. A radio transmission can be so adapted with respect to transmission frequency, amounts of data, range, energy requirement, data collision risk and channel capacity load that the requirements for the sensor signal transmission are met. In particular, these requirements are low power input and short radio protocols.

It is expedient for at least one connection to be provided, to which a diagnosis device is connectable or is connected. The diagnosis device can be an external appliance or an integral component of the transmitter/receiver apparatus. For example, incoming and outgoing radio protocols can be issued by such a diagnosis device. It is possible to read out the current status of sensors and triggered actuators (via the triggering signal). It is also possible to issue internal states and reports of the control device by means of a diagnosis device.

Expediently, a confirmation mode is provided, in which confirmation signals for received signals are transmittable and/or receivable. Confirmation signals relating to received signals are sent back in the confirmation mode. The transmitting transmitter/receiver apparatus can thereby check whether its transmitted signals were actually transmitted correctly.

Furthermore, a test signal mode can be (alternatively or additionally) provided, in which test signals for testing the transmission reliability are transmittable and/or receivable. In particular, the test signals are regularly or continuously emitted. A transmitter/receiver apparatus (in particular, in the receive mode) can thereby check whether the transmission reliability is guaranteed. If no more test signals are received or test signals are temporarily not received, then there is or was a failure, and a corresponding error report can be issued.

In particular, the control device comprises a test device which evaluates the reception of test signals. The transmission reliability can thereby be tested. In particular, the test device has an associated memory for storing fault reports on test signal reception failures. In particular, the fault report as such is stored. It is expedient for attendant circumstances relating to the fault report and, in particular, date and time and possibly duration of the failure to be stored along with it.

A periodic transmit mode can also be provided, in which signals are periodically transmittable. A transmitter/receiver apparatus in the receive mode then knows, when signals do not come in periodically, that there is a transmission failure.

A repeater mode, in which received signals are forwardable, can be provided for the transmitter/receiver apparatus according to the invention. The transmitter/receiver apparatus can thus be used as intermediate amplifier. It is, in turn, therefore possible to build up longer transmission paths. Consequently, sensor signals can also be transmitted over transmission paths which are longer than 30 m, for example, and an actuator can be correspondingly controlled.

In particular, a transmitting function is allocated to an input connection by the control device. Furthermore, a receiving function is allocated to an output connection by the control device. The transmitting and receiving of signals can thus be configured in a simple way by means of the control device. If, for example, a repeater mode is set, received signals are then allocated to an input connection by the control device, and forwarding is thereby made possible. Consequently, the repeater mode can be set in a simple way.

In particular, a plurality of transmitting/receiving channels are provided. Sensor signals from a plurality of sensors can thus be transmitted or received, and a plurality of actuators can be triggered.

In particular, a transmitting channel is allocated to at least one input connection. The allocation can be “wired” or carried out by the control device.

It is also possible for a receiving channel to be allocated to at least one output connection, and, in particular, this allocation can be carried out by the control device, so that it is variable.

It is then also possible for test signals and/or monitoring signals such as, for example, confirmation signals to be transmittable on a transmitting channel and/or a receiving channel. By means of the control device it can be set whether it is a sensor signal or a test signal or monitoring signal.

In one embodiment of the invention, a transmission system for wireless transmission of sensor signals is provided, which is universally usable.

At least two transmitter/receiver apparatuses of the kind according to the invention are used.

In the transmission system according to the invention, a unidirectional or bidirectional transmission of data can be carried out. Sensor signals can also be transmitted over long transmission paths when corresponding repeater transmitter/receiver apparatuses are used.

In particular, a first transmitter/receiver apparatus and a second transmitter/receiver apparatus are allocated to each other, with the first transmitter/receiver apparatus transmitting signals which can be received by the second transmitter/receiver apparatus. The two transmitter/receiver apparatuses can thus communicate with each other. The communication can be unidirectional.

It is also possible for the communication to be bidirectional. For this purpose, signals are transmitted by the second transmitter/receiver apparatus to the first transmitter/receiver apparatus, and these can be received by the first transmitter/receiver apparatus.

It is possible for the second transmitter/receiver apparatus to transmit confirmation signals to the first transmitter/receiver apparatus. The first transmitter/receiver apparatus can thereby ascertain whether the signals have been transmitted correctly.

It is alternatively or additionally possible for the first transmitter/receiver apparatus to transmit test signals to the second transmitter/receiver apparatus, and, in particular, the test signals can be emitted regularly, for example, continuously. The transmission reliability can be tested by means of the test signals.

It is also possible for the second transmitter/receiver apparatus to transmit test signals to the first transmitter/receiver apparatus. This is particularly advantageous when data transmission is bidirectional.

It can also be provided that the first and/or the second transmitter/receiver apparatus periodically transmits signals. In this way, the transmission reliability can be tested. If there is no signal at a specified time, this is then an indication for the corresponding transmitter/receiver apparatus that there is a transmission failure.

It can be provided that the at least one transmitter/receiver apparatus is operated as repeater for forwarding received signals. In this way, an enlarged transmission path can be built up. The repeater transmitter/receiver apparatus operates as intermediate amplifier and forwards signals.

For example, a bidirectional repeater mode is set, in which signals are forwarded bidirectionally.

In one embodiment, an initial transmitter/receiver apparatus, a final transmitter/receiver apparatus and at least one repeater transmitter/receiver apparatus are provided, and confirmation signals and/or test signals are transmitted by the final transmitter/receiver apparatus. In this way, it can be ascertained by the initial transmitter/receiver apparatus whether transmitted signals were correctly transmitted to the last transmitter/receiver apparatus. In bidirectional data exchange, the relations are reversed, i. e., the final transmitter/receiver apparatus then acts as transmitter.

In this sense, it then forms an initial transmitter/receiver apparatus for this transmission path.

A first transmission branch with at least one repeater transmitter/receiver apparatus and at least one second transmission branch with at least one repeater transmitter/receiver apparatus can be provided. In this way, data can be independently transmitted in n (with n≧2) different transmission branches. It is thus possible to increase the transmission reliability and to provide an improved reception.

In particular, the transmission branches are arranged in parallel. They can thus be configured independently.

It is possible for an OR operation and/or an AND operation to be carried out with respect to input signals from different transmission branches at a final transmitter/receiver apparatus. The transmission sensitivity can thereby be increased (with the OR operation) as several series of signals can be used. With an AND operation, a transmission fault can be easily detected and corresponding measures taken.

The following description of preferred embodiments serves to explain the invention in greater detail in conjunction with the drawings, in which:

### BRIEF DESCRIPTION OF THE DRAWINGS

FIG. 1 shows a schematic representation of an embodiment of a transmitter/receiver apparatus according to the invention;

FIG. 2 shows a first embodiment of a transmission system according to the invention;

FIG. 3 shows a second embodiment of a transmission system according to the invention;

FIG. 4 shows a third embodiment of a transmission system according to the invention;

FIG. 5 shows a partial representation of a fourth embodiment of a transmission system according to the invention;

FIG. 6 shows a fifth embodiment of a transmission system according to the invention; and

FIG. 7 shows a sixth embodiment of a transmission system according to the invention.

### DETAILED DESCRIPTION OF THE INVENTION

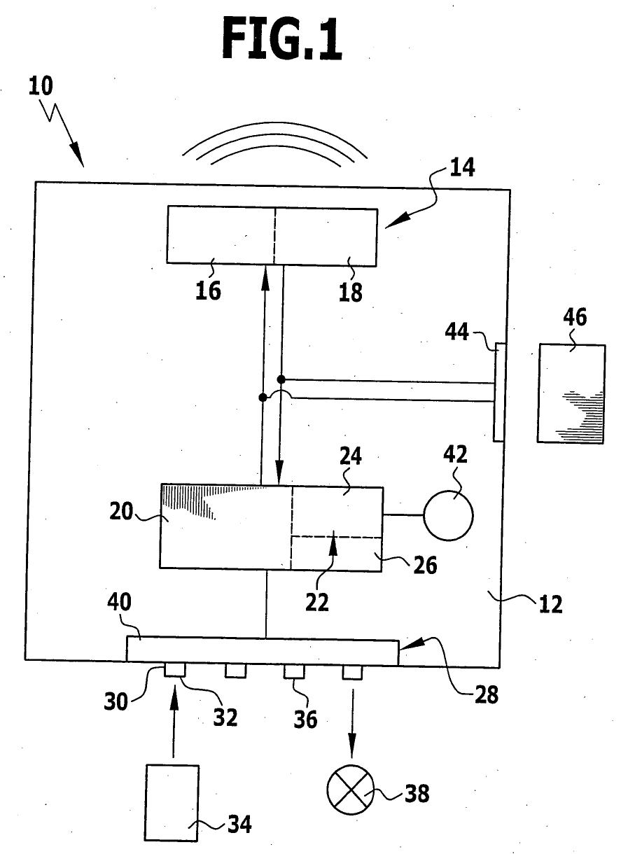

An embodiment of a transmitter/receiver apparatus according to the invention, which is shown in FIG. 1 and designated 10 therein, comprises a carrier 12, on which a transceiver module 14 is arranged.

The transceiver module 14 comprises a transmitting device 16 and a receiving device 18. The transmitting device 16 serves to transmit signals, and the receiving device 18 serves to receive signals.

It is, in principle, possible for the transmitting device 16 and the receiving device 18 to be separate from each other and independent of each other. In the transmitter/receiver apparatus 10, the transmitting device 16 and the receiving device 18 are integrated into the transceiver module 14.

The transmitter/receiver apparatus 10 is so configured that it is usable in the field of sensor technology, and, in particular, sensor signals are wirelessly transmittable. The transmitter/receiver apparatus 10 is appropriately set for this purpose, in particular, with respect to transmission frequency or transmission frequencies of transmitted signals, amounts of data, signal range, energy requirement, data collision risk and channel capacity load.

In particular, the signals are transmitted wirelessly by radio. It has been found that low power inputs and short data protocols are achievable with radio transmission systems. The ZigBee standard IEEE 802.15.4 is one possible standard.

A TCM 120 radio module of the company EnOcean was used as transceiver module 14 in one concrete embodiment. The radio frequency there is 868 MHz with a radio protocol of 14 bytes in length.

The transceiver module 14 has an associated control device 20 for controlling the transfer of data by the transmitting device 16 and the receiving device 18.

The control device 20 also comprises an evaluating device 22 for evaluating, for example, sensor switching states. The evaluating device 22 can comprise, for example, a test device 24 for evaluating test signals, and the test device 24 can have an associated memory 26 for storing error signals.

The control device 20 is implemented by, for example, a microcontroller.

The control device 20 is connected to a connection device 28 comprising one or a plurality of connections 30. At least one input connection 32 is provided, to which a sensor 34 can be coupled for coupling a sensor signal into the transmitter/receiver apparatus 10 for wireless transmission.

Furthermore, at least one output connection 36 is provided for coupling out a received signal, in particular, a sensor signal. A coupled-out signal can have been previously processed by the evaluating device 22.

An actuator 38 controllable by an output signal can be coupled to the output connection 36. If, for example, an output signal is a sensor switching signal (possibly previously processed in the evaluating device 22) then an actuator 38 is supplied with a switching signal. Corresponding operations can be switched by such a switching signal.

Separate input connections 32 and separate output connections 36 are provided in the embodiment shown in FIG. 1. In particular, a plurality of input connections 32 and a plurality of output connections 36 are provided. A plurality of sensors 34 and a plurality of actuators 38 can thus be coupled.

It is, in principle, also possible for one or a plurality of connections 30 to be provided, which are switchable by means of the control device 20 as input connection 32 or output connection 36. The control device 20 then determines whether the corresponding connection 30 is an input connection or an output connection, and the type of connection can be changed. Thus, for example, at a certain point in time a sensor signal can be coupled into a connection 30, and at another point in time an actuator signal can be coupled out at the same connection.

It is also possible for the connection occupancy of the connection device 28 to be settable by a setting device. With DIP switches, for example, it can be set for each connection 30 whether it is an input connection or an output connection. In this way, use of the corresponding transmitter/receiver apparatus 10 is variable. For this settability, the connection device 28 comprises as setting device a switching module 40 which is in operative connection with the connections 30.

The control device 20 can have an associated input device 42, for example, in the form of a key. In particular, teach-in operations can then be performed using the input device 42.

Furthermore, it can be provided that the transmitter/receiver apparatus 10 comprises an interface 44 for an external diagnosis device 46. The interface 44 is coupled, in particular, to connection lines between the control device 20 and the transceiver module 14.

Radio protocols on incoming signals and/or outgoing signals can be transmitted to the diagnosis device 46 via the interface 44. Furthermore, if sensors and/or actuators are connected, their current status can be read out (via the corresponding signals).

Furthermore, it is also possible for internal states and reports of the control device 20 to be issued.

Instead of an external diagnosis device 46, a diagnosis device can be integrated into the transmitter/receiver apparatus 10 in order to provide a user directly with the corresponding information.

The radio communications received from the transmitting device 16 are passed on to the control device 20. This takes place by means of, for example, a serial protocol. Communications that are to be transmitted are transferred from the control device 20 to the receiving device 18 by means of a serial protocol.

For example, the configuration of the connection device 28 with respect to input connections 32 and output connections 36 can be evaluated via the control device 20 with the evaluating device 22. Furthermore, the transceiver module 14 can be initialized. Sensor switching states can be evaluated. Furthermore, it is provided that the transmitting device 16 of the transceiver module 14 is triggered via the control device 20 to transmit sensor signals (i. e. sensor states). Incoming communications supplied by the receiving device 18 are evaluated by the evaluating device 22. Furthermore, the control device 20 triggers corresponding actuators 38 when signals come in. If necessary, a check is made beforehand as to which actuator 38 is to be triggered or whether an actuator is to be triggered at all. The control device 20 can provide a status display for sensors 34 and actuators 38, and the status display is issued via, for example, a diagnosis device. Display elements such as, for example, light-emitting diodes can also be arranged on the carrier 12.

The control device 20 can also provide for storage of received communications. Furthermore, an error recognition is possible, in particular, by the test device 24 of the evaluating device 22. Also, issue of status information and of incoming (radio) communications is possible by means of the control device 20.

The transmitter/receiver apparatus 10 can have various operating modes, which are also combinable. Data are transmitted in a transmit mode, and data are received in a receive mode. If both transmit mode and receive mode are active, data can then be transmitted and received, i. e., a bidirectional exchange of data is possible.

Confirmation signals for received signals can be transmitted and/or received in a confirmation mode. For example, it is ensured that the transmitting device 16 transmits confirmation signals when the receiving device 18 has received signals. The transmitter can thereby be notified that signals were successfully received. This will be explained in further detail hereinbelow.

Test signals are transmitted, and, in particular, regularly or continuously transmitted, in a test signal mode. The transmission reliability can thereby be tested. If, for example, a transmitter/receiver apparatus 10 does not receive a test signal, this is then an indication that there is a fault. The test device 24 can then emit an error signal, which is stored, for example, in a memory 26. The storage is for documentation purposes. In particular, an error report with characteristic data such as date, time and duration can be stored.

It can, for example, happen that while a transmission path is in operation, the transmission is disturbed or interrupted by objects getting into the transmission path. Such disturbances can be monitored by transmitting test signals.

In principle, it is possible for a channel of their own to be used for transmitting test signals. It is, however, also possible for a channel that is provided in connection with signal transmission and/or signal reception to be used for transmitting test signals.

On switching on the transmitter/receiver apparatus 10, an initializing process is initiated, in which the transmitting device 16 recognizes the transceiver module 14 with the transmitting device 16 and the receiving device 18. It can be provided that an individual identification of the transceiver module 14 is read out and, for example, stored in the memory 26 by the control device 20. Furthermore, during the initialization, the settings of the switching module 40 and hence the configuration of the connections 30 are read into the control device 20. A function (input connection or output connection) can thereby be allocated to each connection 30 in the control device 20.

In principle, it is possible for radio signal communications that are receivable by the receiving device 18 to be programmed. For this purpose, for example, the receiving sensitivity of the transceiver module 14 is reduced. More remote transmitter/receiver apparatuses that transmit radio signals can thereby be faded out. Programming can be carried out by actuating the input device 42. For example, if a key is provided as input device 42, a first output connection 36 is selected by pressing once, a second output connection by pressing twice, etc.

The control device 20 allocates incoming signals to the correspondingly activated channel. Incoming communication signals can be stored in an associated memory. Corresponding radio protocols are allocated to a corresponding output connection 36 in order that a corresponding actuator can be activated or deactivated.

During “normal” operation of the transmitter/receiver apparatus 10, the input connection or connections 32 are checked, in a receiving operation mode, for example, sequentially, for a change in the signals present. If a change occurs, a radio communication is generated and this is transmitted by the transmitting device 16. If an incoming radio communication is detected by the control device 20, the testing operations with respect to the input connection or connections 32 are then interrupted by means of an interrupt. The control device 20 with the evaluating device 22 checks the incoming signals with stored channels and, when an incoming radio communication was detected in accordance with a channel, allocates it to the corresponding output connection 36. Depending on the incoming communication, the corresponding actuator 38 is then deactivated or activated.

The switching states of the connected sensors 34 are detected in the transmitting operation mode of the transmitter/receiver apparatus 10 (transmitting operation mode and receiving operation mode can be simultaneously active). A communication protocol is generated in the control device 20, and the corresponding signals are transmitted, for example, serially, to the transceiver module 14. The control device 20 with its evaluating device 22 can check whether the signals are to be sent out at all. For example, the control device 20 checks whether confirmation signals are present. If, for example, confirmation signals do not come in from a corresponding transmitter/receiver apparatus within a prescribed time, a series of signals is then sent again.

It can be provided that the output connection configuration is stored so that after the transmitter/receiver apparatus 10 is switched off and switched on again, the corresponding configuration is immediately available again without a teach-in operation having to be performed.

In a transmission system according to the invention for wireless transmission of sensor signals, at least two transmitter/receiver apparatuses, as described above, cooperate.

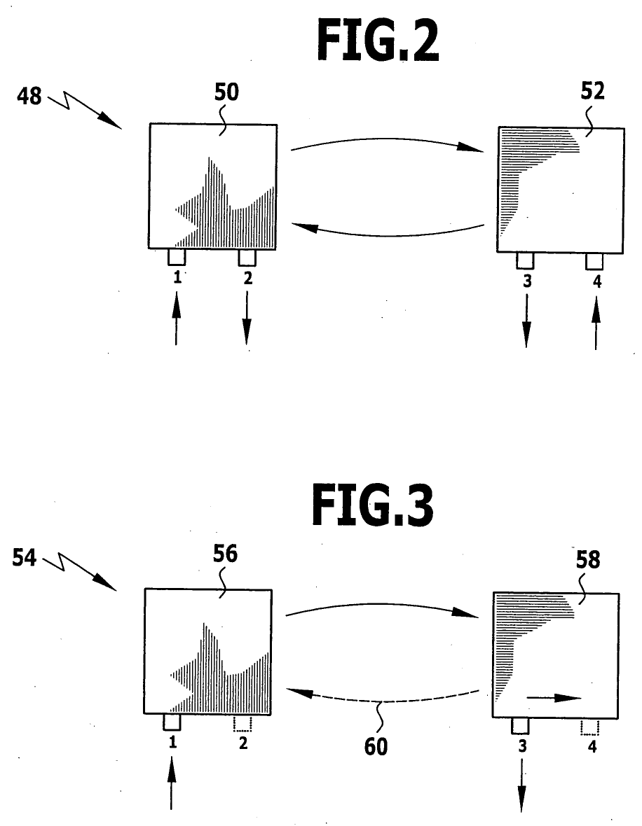

In a first embodiment of such a transmission system, shown schematically in FIG. 2 and generally designated 48 therein, a first transmitter/receiver apparatus 50 and a second transmitter/receiver apparatus 52 are provided, and the two transmitter/receiver apparatuses 50, 52 communicate with each other. For example, a sensor is connected to an input connection 1 of the first transmitter/receiver apparatus 50. Its sensor signals are transmitted (possibly after processing by the evaluating device 22), for example, by radio to the second transmitter/receiver apparatus 52. Corresponding output signals are provided at an output connection 3 of the transmitter/receiver apparatus 52 in order, for example, to supply these to an actuator.

The described transmission branch is unidirectional when the first transmitter/receiver apparatus 50 only transmits and the second transmitter/receiver apparatus 52 only receives.

Bidirectional operation is also possible, in which also the second transmitter/receiver apparatus 52 transmits and the first transmitter/receiver apparatus 50 receives signals.

For example, for this purpose, a sensor is connected to an input connection 4 of the transmitter/receiver apparatus 52, and corresponding sensor signals (possibly after processing) are transmitted to the first transmitter/receiver apparatus 50. The latter comprises an output connection 2 at which corresponding sensor signals (possibly after processing) can be read out in order, for example, to control an actuator.

In a second embodiment of a transmission system according to the invention, which is shown schematically in FIG. 3 and generally designated 54 therein, a first transmitter/receiver apparatus 56 is, again, provided, and a second transmitter/receiver apparatus 58 is provided. A sensor is connected to an input connection 1 of the transmitter/receiver apparatus 56, and corresponding sensor signals are transmitted by the first transmitter/receiver apparatus 56. Sensor signals can be coupled out at an output connection 3 of the second transmitter/receiver apparatus 58.

It can be provided that a control device 20 of the second transmitter/receiver apparatus 58 recognizes the switching state of the output connection 3 and allocates this to an input connection 4. The control device 20 then considers the received signal as input signal at the input connection 4, too. This signal can then be emitted by the second transmitter/receiver apparatus 58 and serves the first transmitter/receiver apparatus 56 as confirmation signal. (The confirmation signal is indicated schematically by reference numeral 60 in FIG. 3.)

The corresponding control device of the first transmitter/receiver apparatus 56 allocates the confirmation signal 60 to an output connection 2. It checks, for example, whether the emitted signal and the confirmation signal match.

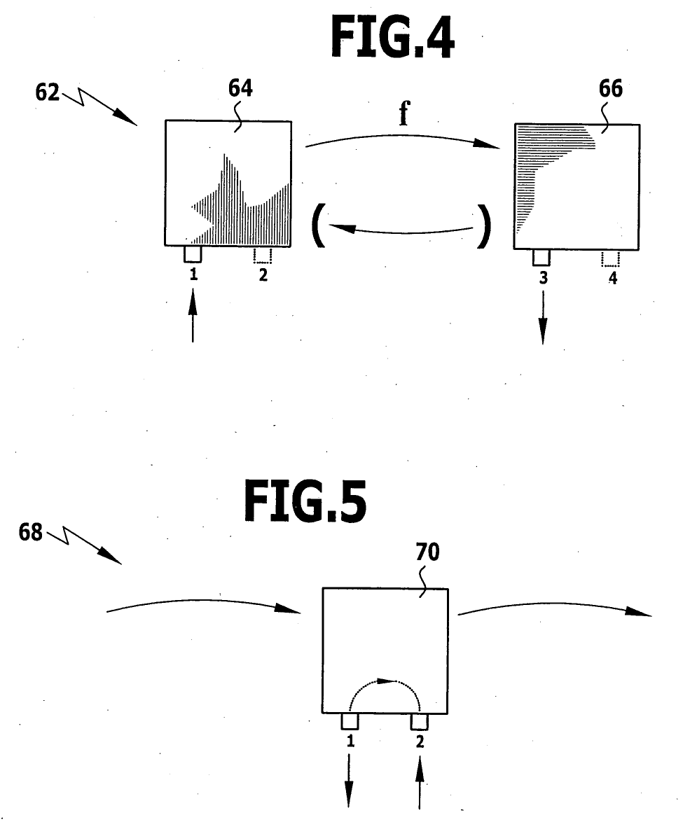

In a third embodiment of a transmission system according to the invention, which is shown schematically in FIG. 4 and generally designated 62, a first transmitter/receiver apparatus 64 is again provided. Furthermore, a second transmitter/receiver apparatus 66 is provided. The two transmitter/receiver apparatuses 64 and 66 communicate as described, for example, with reference to the embodiment 48 or the embodiment 54.

Herein it is provided that the first transmitter/receiver apparatus 64 emits periodic signals and, optionally, the second transmitter/receiver apparatus 66 emits periodic signals (insofar as bidirectional transmission is provided or confirmation signals are transmitted).

If a periodic signal fails, which is easily recognizable by the first transmitter/receiver apparatus 64 or the second transmitter/receiver apparatus 66, an error report is then issued, for example. For this purpose, for example, an output connection 4 of the second transmitter/receiver apparatus 66 is brought into a defined state.

In the case of bidirectional transmission or failure of a confirmation signal, an output connection 2 of the first transmitter/receiver apparatus 64 is brought into a defined state and an error report is issued.

In a fourth embodiment of a transmission system according to the invention, which is shown in partial representation in FIG. 5 and designated 68 therein, an initial transmitter/receiver apparatus and a final transmitter/receiver apparatus, which are configured as described above, are provided. At least one further transmitter/receiver apparatus 70, which operates in a repeater mode, is arranged between such an initial transmitter/receiver apparatus and such a final transmitter/receiver apparatus. The transmission path over which sensor signals are wirelessly transmittable can be enlarged by this at least one further transmitter/receiver apparatus 70. The at least one further transmitter/receiver apparatus 70 operates as intermediate amplifier.

It comprises, for example, an output connection 1. Incoming communication signals are allocated to this output connection 1 by the corresponding control device and are then further allocated to an input connection 2. They are then passed on.

If n further transmitter/receiver apparatuses 70 are provided, it is then possible to pass on signals via n locations with a corresponding enlargement of the transmission branch.

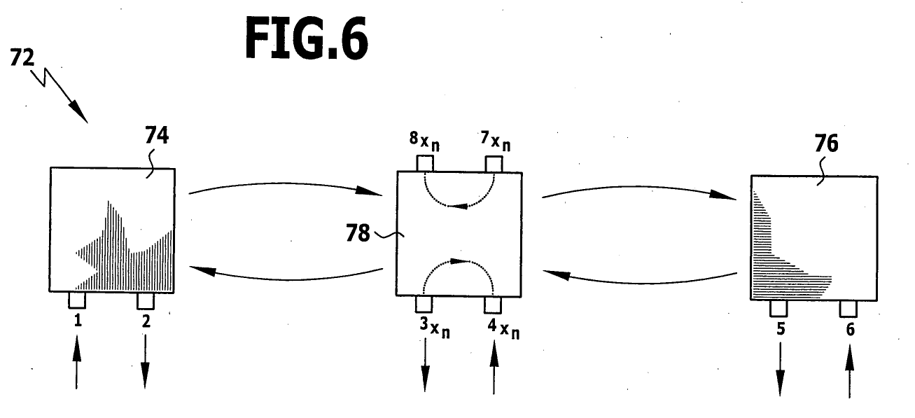

In a fifth embodiment, which is shown schematically in FIG. 6 and is designated 72 therein, an initial transmitter/receiver apparatus 74 is provided and also a final transmitter/receiver apparatus 76 with at least one further transmitter/receiver apparatus 78 in the repeater mode located between these. Herein signals are passed on as described above with reference to the transmission system 68.

It is provided that the transmitter/receiver apparatuses 74, 76 and 78 operate bidirectionally. The final transmitter/receiver apparatus 76 transmits signals to the further transmitter/receiver apparatus 78 which passes these signals on to transmitter/receiver apparatuses in the repeater mode located between these until the signals are received by the initial transmitter/receiver apparatus 74.

For the forwarding of signals, the at least one further transmitter/receiver apparatus 78 is controlled or switched as described with reference to the transmission system 68.

It is additionally or alternatively possible for confirmation signals to be transmitted by the final transmitter/receiver apparatus 76.

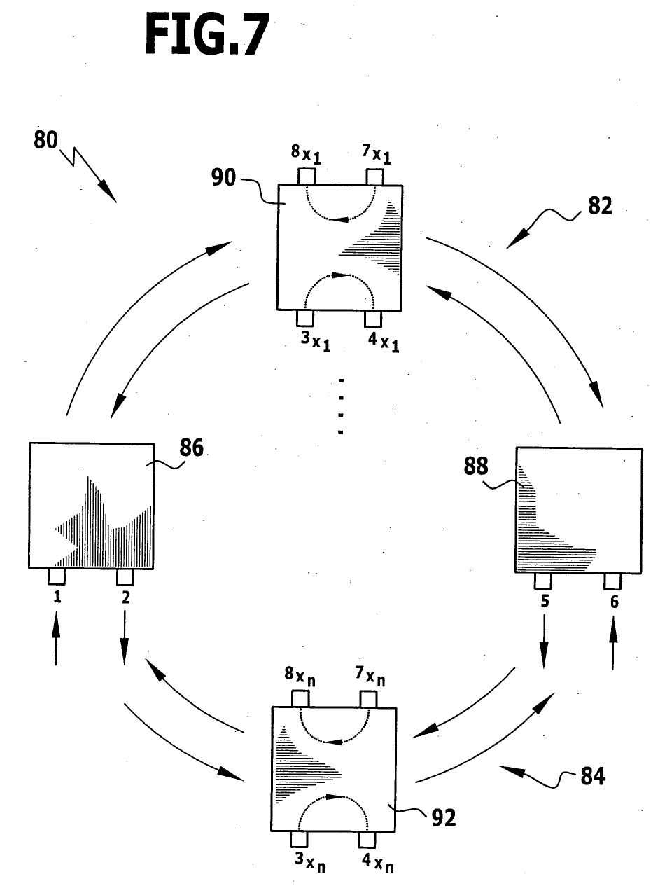

In a sixth embodiment of a transmission system according to the invention which is shown schematically in FIG. 7 and designated 80 therein, a first transmission branch 82 is provided, and a second independent transmission branch 84 is provided. There can also be further (independent) transmission branches.

The first transmission branch 82 and the second transmission branch 84 are allocated to an initial transmitter/receiver apparatus 86 and a final transmitter/receiver apparatus 88.

The first transmission branch 82 is formed by at least one further transmitter/receiver apparatus 90 in the repeater mode. The second transmission branch 84 is likewise formed by at least one further transmitter/receiver apparatus 92 in the repeater mode.

The first transmission branch 82 corresponds, in principle, to the transmission path as described in conjunction with the transmission system 68 or the transmission system 72. This applies to the second transmission branch 84 as well.

Data can be transmitted unidirectionally or bidirectionally in the first transmission branch 82 and in the second transmission branch 84. Transmission of confirmation signals can also be alternatively or additionally provided.

In the case of unidirectional data transmission, the final transmitter/receiver apparatus 88 receives—if there are no signal failures—several communications based on the same initial communication. The transmission reliability can be increased by the parallel connection with at least two transmission branches 82, 84.

For example, an OR operation is carried out at the final transmitter/receiver apparatus. In this way, signal reception is possible even if there is a transmission failure in a transmission branch.

The same applies analogously to the bidirectional transmission or when confirmation signals are transmitted, and the corresponding check is then made at the initial transmitter/receiver apparatus 86.

It is also possible for an AND operation to be carried out at the final transmitter/receiver apparatus 88. It can thereby be checked whether the received communications differ. If a difference is ascertained, this can then be attributed to a transmission error in at least one transmission path 82, 84. A warning signal is then issued, for example.

The same procedure can also be selected when bidirectional data transmission takes place or confirmation signals are transmitted. A corresponding check is then made at the initial transmitter/receiver apparatus 86.

Sensor signals can be wirelessly transmitted and received, for example, over a distance of 10 to 30 m or further (particularly when repeater transmitter/receiver apparatuses are used) with the transmitter/receiver apparatus according to the invention and the transmission system according to the invention. A corresponding transmitter/receiver apparatus can be positioned in the proximity of one sensor or a plurality of sensors in an application. On the basis of received sensor signals, an actuator can then be controlled and, in particular, activated or deactivated by means of a further transmitter/receiver apparatus. In particular, multi-channel transmission is possible, i. e., sensor signals of a plurality of sensors can be transmitted and received. The data transmission can be unidirectional or bidirectional. It is possible for test signals to be transmitted (and received) and/or for confirmation signals to be transmitted and received.

1-39. (canceled)

40. Transmitter/receiver apparatus for sensor signals, comprising:
a transmitting device for wirelessly transmitting signals;
a receiving device for receiving wirelessly transmitted signals;
a connection device to which at least one sensor is connectable for signal input, and which has at least one connection for signal output; and
a control device which is connected to the connection device, the transmitting device and the receiving device;
wherein the signal traffic between the connection device, the transmitting device and the receiving device is controllable by means of the control device.

41. Transmitter/receiver apparatus in accordance with claim 40, wherein the control device comprises an evaluating device for signal evaluation.

42. Transmitter/receiver apparatus in accordance with claim 40, wherein the connection device comprises at least one input connection and at least one output connection.

43. Transmitter/receiver apparatus in accordance with claim 42, wherein a plurality of input connections are provided.

44. Transmitter/receiver apparatus in accordance with claim 42, wherein a plurality of output connections are provided.

45. Transmitter/receiver apparatus in accordance with claim 42, wherein the least one input connection and the least one output connection are spatially separated.

46. Transmitter/receiver apparatus in accordance with claim 42, wherein at least one connection is provided, which is switchable as input connection or as output connection.

47. Transmitter/receiver apparatus in accordance with claim 40, wherein a setting device is provided by means of which at least one connection of the connection device is settable as input connection or output connection.

48. Transmitter/receiver apparatus in accordance with claim 40, wherein the transmitting device and the receiving device are integrated into a transceiver module.

49. Transmitter/receiver apparatus in accordance with claim 40, wherein the transmitting device is configured as radio transmitting device.

50. Transmitter/receiver apparatus in accordance with claim 40, wherein the receiving device is configured as radio receiving device.

51. Transmitter/receiver apparatus in accordance with claim 40, wherein at least one connection is provided, to which a diagnosis device is connectable or connected.

52. Transmitter/receiver apparatus in accordance with claim 40, wherein a confirmation mode is provided, in which confirmation signals for received signals are at least one of transmittable and receivable.

53. Transmitter/receiver apparatus in accordance with claim 40, wherein a test signal mode is provided, in which test signals for testing the transmission reliability are at least one of transmittable and receivable.

54. Transmitter/receiver apparatus in accordance with claim 53, wherein the control device comprises a test device which evaluates the reception of test signals.

55. Transmitter/receiver apparatus in accordance with claim 54, wherein the test device has associated with it a memory in which fault reports on test signal reception failures are storable.

56. Transmitter/receiver apparatus in accordance with claim 40, wherein a periodic transmit mode is provided, in which signals are periodically transmittable.

57. Transmitter/receiver apparatus in accordance with claim 40, wherein a repeater mode is provided, in which received signals are forwardable.

58. Transmitter/receiver apparatus in accordance with claim 40, wherein a transmitting function is allocated to an input connection by the control device.

59. Transmitter/receiver apparatus in accordance with claim 40, wherein a receiving function is allocated to an output connection by the control device.

60. Transmitter/receiver apparatus in accordance with claim 40, wherein a plurality of transmitting/receiving channels are provided.

61. Transmitter/receiver apparatus in accordance with claim 60, wherein a transmitting channel is allocated to at least one input connection.

62. Transmitter/receiver apparatus in accordance with claim 60, wherein a receiving channel is allocated to at least one output connection.

63. Transmitter/receiver apparatus in accordance with claim 60, wherein at least one of test signals and confirmation signals are transmittable on at least one of a transmitting channel and a receiving channel.

64. Transmission system for wireless transmission of sensor signals, which comprises at least two transmitter/receiver apparatuses, said transmitter/receiver apparatuses comprising each:
a transmitting device for wirelessly transmitting signals;
a receiving device for receiving wirelessly transmitted signals;
a connection device to which at least one sensor is connectable for signal input, and which has at least one connection for signal output; and
a control device which is connected to the connection device, the transmitting device and the receiving device;
wherein the signal traffic between the connection device, the transmitting device and the receiving device is controllable by means of the control device.

65. Transmission system in accordance with claim 64, wherein a first transmitter/receiver apparatus and a second transmitter/receiver apparatus are allocated to each other, and the first transmitter/receiver apparatus transmits signals which are receivable by the second transmitter/receiver apparatus.

66. Transmission system in accordance with claim 65, wherein the signal transmission is bidirectional, and signals are transmittable by the second transmitter/receiver apparatus to the first transmitter/receiver apparatus.

67. Transmission system in accordance with claim 65, wherein the second transmitter/receiver apparatus transmits confirmation signals to the first transmitter/receiver apparatus.

68. Transmission system in accordance with claim 65, wherein the first transmitter/receiver apparatus transmits test signals to the second transmitter/receiver apparatus.

69. Transmission system in accordance with claim 65, wherein the second transmitter/receiver apparatus transmits test signals to the first transmitter/receiver apparatus.

70. Transmission system in accordance with claim 65, wherein the first transmitter/receiver apparatus transmits signals periodically.

71. Transmission system in accordance with claim 65, wherein the second transmitter/receiver apparatus transmits signals periodically.

72. Transmission system in accordance with claim 64, wherein at least one transmitter/receiver apparatus is operated as repeater which forwards received signals.

73. Transmission system in accordance with claim 72, wherein a bidirectional repeater mode is provided.

74. Transmission system in accordance with claim 72, wherein an initial transmitter/receiver apparatus, a final transmitter/receiver apparatus and at least one repeater receiver/transmitter apparatus are provided, and at least one of confirmation signals and test signals are transmitted by the final transmitter/receiver apparatus.

75. Transmission system in accordance with claim 72, wherein a first transmission branch with at least one repeater transmitter/receiver apparatus and at least a second transmission branch with at least one repeater transmitter/receiver apparatus are provided.

76. Transmission system in accordance with claim 75, wherein the transmission branches are arranged in parallel.

77. Transmission system in accordance with claim 75, wherein an OR operation with respect to sensor signals from different transmission branches is performed at a final transmitter/receiver apparatus.

78. Transmission system in accordance with claim 75, wherein an AND operation with respect to sensor signals from different transmission branches is performed at a final transmitter/receiver apparatus.
